(19) United States
(12) Patent Application Publication
(10) Pub. No.: US 2014/0016150 A1
(43) Pub. Date: Jan. 16, 2014

(54) SYSTEM AND METHOD TO STORE EMBEDDED FONTS

(71) Applicant: Takayuki Kamata, Boulder, CO (US)

(72) Inventor: Takayuki Kamata, Boulder, CO (US)

(73) Assignee: KONICA MINOLTA LABORATORY U.S.A., INC., San Mateo, CA (US)

(21) Appl. No.: 13/549,227

(22) Filed: Jul. 13, 2012

(51) Int. Cl. G06K 15/02

(52) U.S. Cl. 358/1.11

(57) ABSTRACT

A method for managing a font, including: receiving, by a printer, a first electronic document (ED) identifying the font and embedding a plurality of attributes of the font; determining, by the printer, that the plurality of attributes of the font is not stored on the printer; storing, by the printer, the plurality of attributes of the font extracted from the first ED in a font storage unit; and generating, by the printer and based on a layout of the first ED, a hardcopy of the first ED having a first printed value in the font.

### BACKGROUND OF INVENTION

Many users generate electronic documents (EDs) on a daily basis. Moreover, these EDs may have very sophisticated and/or uncommon fonts. When a printer receives an ED for printing, it is possible that one or more of the fonts specified in the ED are not supported by the printer. As a result, the hardcopy of the ED may have fonts that differ from the expected fonts. Regardless, users still wish to generate and print EDs having sophisticated and/or uncommon fonts.

### SUMMARY OF INVENTION

In general, in one aspect, the invention relates to a method for managing a font. The method comprises: receiving, by a printer, a first electronic document (ED) identifying the font and embedding a plurality of attributes of the font; determining, by the printer, that the plurality of attributes of the font is not stored on the printer; storing, by the printer, the plurality of attributes of the font extracted from the first ED in a font storage unit; and generating, by the printer and based on a layout of the first ED, a hardcopy of the first ED comprising a first printed value in the font.

In general, in one aspect, the invention relates to a non-transitory computer-readable medium (CRM) storing a plurality of instructions for managing a font. The plurality of instructions comprise functionality to: receive, using a printer, a first electronic document (ED) identifying the font and embedding a plurality of attributes of the font; determine, using the printer, that the plurality of attributes of the font is not stored on the printer; store the plurality of attributes of the font extracted from the first ED in a font storage unit on the printer; and generate, using the printer and based on a layout of the first ED, a hardcopy of the first ED comprising a first printed value in the font.

In general, in one aspect, the invention relates to a printer for managing a font. The printer comprises: a processor; a font storage unit; an input module executing on the processor and configured to: receive a first electronic document (ED) identifying a font and embedding a plurality of attributes of the font; and receive a second ED identifying the font but not embedding the plurality of attributes; a parsing module operatively connected to the storage unit and configured to: determine, during a parsing of the first ED, that the plurality of attributes is not stored in the font storage unit; store the plurality of attributes in the font storage unit; determine, during a parsing of the second ED, that the plurality of attributes is stored in the font storage unit; and retrieve the plurality of attributes from the font storage unit; and a layout engine executing on the processor and configured to: generate a hardcopy of the first ED comprising a first printed value in the font; and generate, after the plurality of attributes are retrieved from the font storage unit, a hardcopy of the second ED comprising a second printed value in the font.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIG. 3 shows an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for managing a font. Specifically, in response to receiving an ED identifying a font and embedding one or more attributes of the font, the printer may store the attributes. In response to receiving a subsequent ED identifying the font but not embedding the attributes, the printer may retrieve the stored attributes of the font in order to generate a hardcopy of the subsequent ED. The hardcopy of the ED and the hardcopy of the subsequent ED may each have at least one printed value in the font.

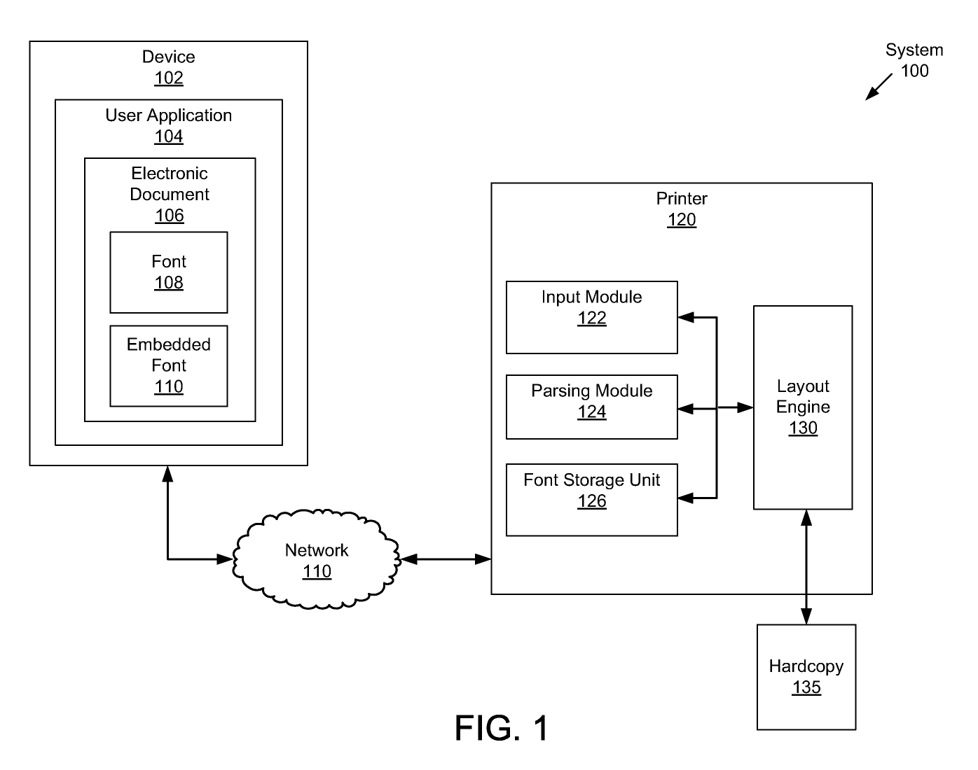

FIG. 1 shows a system (100) in accordance with one or more embodiments of the invention. As shown in FIG. 1, the system (100) has multiple components including device (102) and printer (120) connected via a network (110) with wired and/or wireless segments. The device (102) may correspond to a server, a mainframe, a desktop Personal Computer (PC), a laptop, a Personal Digital Assistant (PDA), a telephone, a smart phone, a kiosk, a cable box, and/or any other hardware device.

In one or more embodiments of the invention, the device (102) executes the user application (104). The user application (104) is a software application operated by a user and configured to obtain, input, generate, display, and/or print an ED (e.g., Electronic Document (106)) having any number of pages. Accordingly, the user application (104) may be a word processor, an Internet browser, slide presentation software, desktop publishing software, spreadsheet software, graphics software, video editor, and so forth. The ED (106) may be a report or form.

In one or more embodiments of the invention, the ED (106) includes text to be displayed and/or printed. The ED (106) may specify/identify the one or more fonts (e.g., font (108)) in which the text of the ED (106) should be displayed and/or printed. In addition to specifying/identifying the font(s), the ED (106) may also include attributes of the font(s) (e.g., within a font file). The attributes may include curves, drawing instructions, and mathematical formulae to describe each glyph (e.g., each character, each symbol, etc.). The attributes may include a matrix of dots or pixels representing the image of each glyph (e.g., each character, each symbol, etc.) in each face and size. The attributes may include a series of specified lines and additional information to define the profile, or size and shape of the line in a specific face, which together describe the appearance of each glyph (e.g., each character, each symbol). When the ED (106) includes the attributes of a font specified/identified in the ED (106), the font is referred to as an embedded font (e.g., Embedded Font (110)). In other words, the ED (106) embeds the attributes of the font.

In one or more embodiments of the invention, the ED (106) is represented/defined using a document markup language (e.g., open document format (ODF), office open XML (OOXML), etc.). Accordingly, the font(s) in the ED (106) may be recorded as attributes within the tags of the document markup language. Moreover, these font(s) are needed to correctly render the ED (106) for display or printing.

In one or more embodiments of the invention, the printer (120) is a Multi-Function Printer (MFP). In other words, the printer (120) may include a scanner (not shown) for inputting (i.e., scanning) documents, a fax module (not shown) for sending/receiving faxes, and a user interface, such as a touch screen, allowing complex interactions to be performed at the MFP itself, rather than having to use another device, such as a computer. It will be clear to one of ordinary skill in the art that many different functionalities may be included in a MFP and, as such, the invention should not be limited to the above examples.

In one or more embodiments of the invention, the printer (120) includes an input module (122). The input module (122) may be configured to receive the ED (106) from device (102) and store the ED (106) in a queue (not shown). The input module (122) may prioritize the ED (106) with respect to the other EDs (not shown) already stored in the queue.

In one or more embodiments of the invention, the printer (120) includes a parsing module (124). The parsing module (124) may be configured to parse the ED (106) and to determine which font(s) identified in the ED (106) are embedded (i.e., the ED (106) includes the attributes of the font) and which font(s) identified in the ED (106) are not embedded. Further, the parsing module (124) is configured to determine/identify font(s) that are supported by the printer (120). In one or more embodiments of the invention, the printer (120) supports a font if the printer (120) is storing the attributes of the font. Accordingly, the parsing module (124) may be configured to compare a font identified in the ED (106) with a data structure storing the font(s) supported by the printer (120).

In one or more embodiments of the invention, the parsing module (124) is configured to store the attributes of a font embedded in the ED (106) on the printer (120). In one or more embodiments of the invention, the parsing module (124) is configured to retrieve the attributes of a font stored on the printer (120). The attributes may be retrieved in response to the ED (106) specifying a font that is not embedded in the ED (106) but supported by the printer (120).

In one or more embodiments of the invention, font storage unit (126) is a data structure of any type or memory located on the printer (120) that is used to store the attributes of one or more fonts. In one or more embodiments of the invention, font storage unit (126) may come pre-loaded with font attributes. In one or more embodiments of the invention, the font storage unit (126) is external (i.e., remote) to the printer (120).

In one or more embodiments of the invention, the printer (120) includes a layout engine (130). The layout engine (130) is configured to generate the hardcopy (135) of the ED (106) (i.e., print the ED (106)). In one or more embodiments of the invention, the layout engine (130) may generate page images. In the case of EDs described/represented using a document markup language (e.g., OOXML), the layout engine (130) may calculate the page positions (i.e., coordinates) of all elements on the pages. In other words, the layout engine (130) may execute a layout of the ED (106) according to the font(s) specified/embedded in the ED (106) and/or supported by the printer (120). The hardcopy (135) includes one or more printed values (e.g., text) in the one or more font(s) identified in the ED (106).

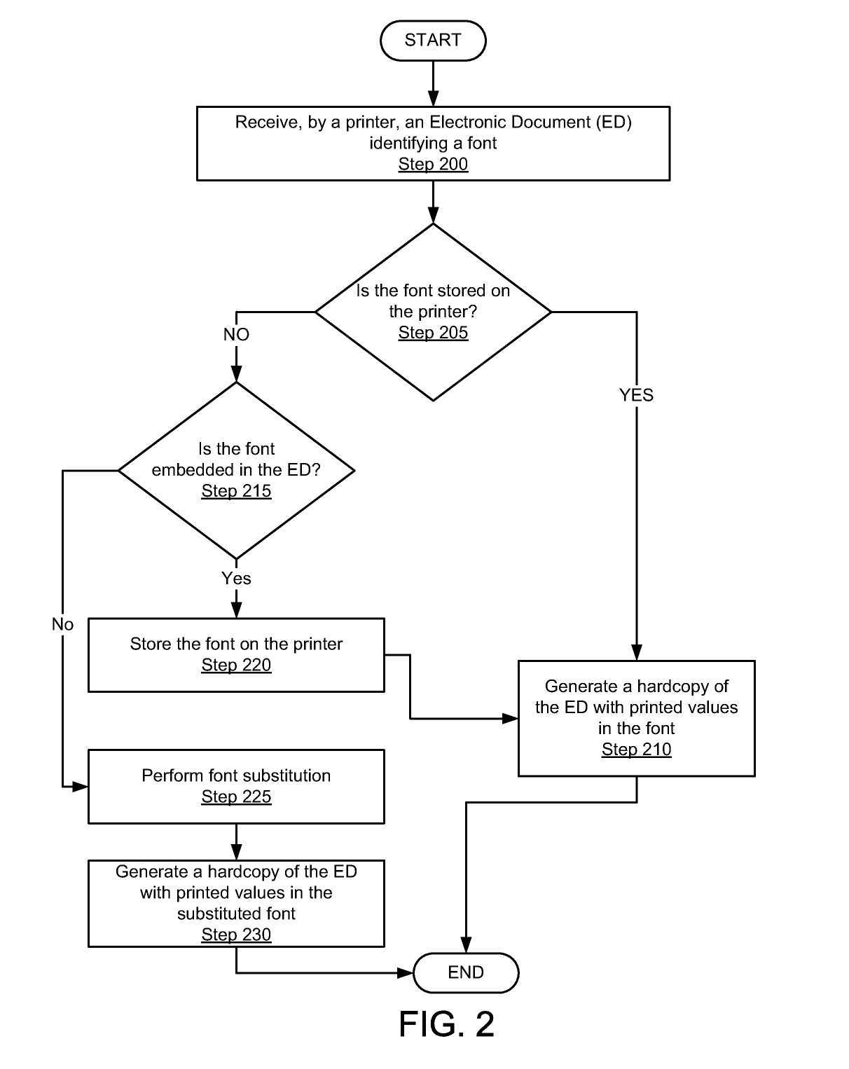

FIG. 2 shows a flowchart in accordance with one or more embodiments of the invention. The process shown in FIG. 2 may be used, for example, with the components of system (100) (e.g., printer (120), discussed above in reference to FIG. 1) to manage a font. One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

In Step 200, an ED identifying a font is received. In one or more embodiments of the invention, the ED may be received in OOXML format. Alternatively, any other suitable format may be used. In one or more embodiments of the invention, the ED may be received by the printer from a mobile device through a network of any size having wired and/or wireless segments. The received ED may be stored in a queue and prioritized with respect to other EDs already stored in the queue.

As discussed above, the ED may include text to be printed. The ED may specify/identify a font in which the text (or a portion of the text) of the ED should be printed. In the case of an embedded font, the ED may include the attributes of the font. The font(s) may be identified during a parsing of the ED (i.e., before or during a layout of the ED).

In Step 205, it is determined whether the font is supported by the printer. In other words, it is determined whether the printer is storing the attributes of the font. In one or more embodiments of the invention, this may be done by comparing the font to a list of fonts stored on, or supported by, the printer. In one or more embodiments of the invention, this comparison may include fonts preloaded on the printer, as well as fonts stored using any system and/or process disclosed in this detailed description. If the font is not stored on the printer, the method proceeds to Step 215. If the font is stored on the printer, the method proceeds to Step 210.

In Step 210, a hardcopy of the ED is generated using the font. The hardcopy may be generated in any method now known or later developed. In one or more embodiments of the invention, the hardcopy is generated using a font stored on the printer. Moreover, the hardcopy includes one or more printed values (e.g., text) in the font. After Step 210, the method ends.

Returning to the previous branch, in Step 215, it is determined if the font is embedded. In other words, it is determined if the attributes of the font are included in the ED. As discussed above, the attributes of the font specify/include all the information, data items, mathematical formulae, matrices, etc. needed by the printer to print text in the font. If the font is not embedded, the method proceeds to Step 225. If the font is embedded, the method proceeds to Step 220.

In Step 220, the attributes of the embedded font extracted from the ED are stored on the printer. In one or more embodiments of the invention, the font attributes may be stored in a special data structure for user or custom fonts. Alternatively, the font attributes may be stored with the pre-loaded fonts of the printer. It will be apparent to one of ordinary skill in the art that there are many ways to store font attributes on a printer and, as such, the invention should not be limited to the above examples. After storing the font attributes, the method proceeds to Step 210, where a hardcopy of the ED is generated using the font, as described above.

Returning to the previous branch, in Step 225, font substitution is performed. In one or more embodiments of the invention, font substitution may use any font supported by the printer, both those stored by this method and/or pre-loaded fonts. The default font for substitution may be set by a user or a manufacturer of the printer.

In Step 230, a hardcopy is generated using the substituted font. The hardcopy includes one or more printed values (i.e., text) in the substituted font. In one or more embodiments of the invention, this step may be performed in any method now know or later developed.

The following section describes various examples of the invention. The examples are included to aid in the understanding of the invention but are not intended to limit the scope of the invention.

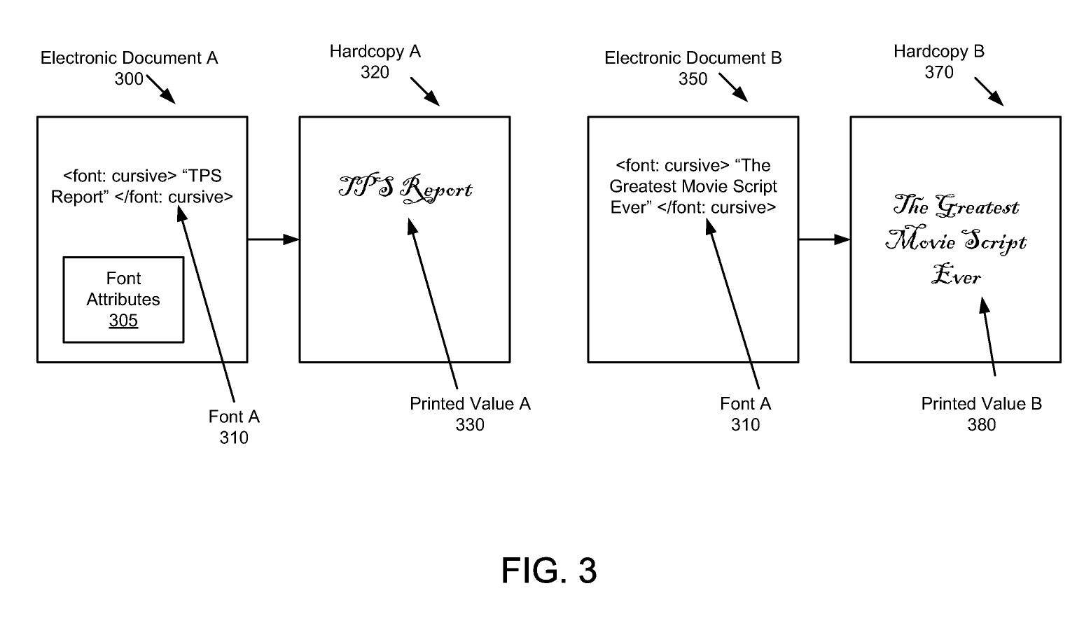

FIG. 3 shows ED A (300) described using OOXML. ED A (300) specifies, using OOXML tags, that the text “TPS Report” is to be printed in “cursive” (i.e., Font A (310)). In addition to specifying/identifying “cursive” (i.e., Font A (310)), ED A (300) includes the font attributes (305) of Font A (310). In other words, Font A (310) is an embedded font, and the font attributes (305) of Font A (310) are included in ED A (300). The attributes may include curves, drawing instructions, and mathematical formulae to describe each glyph (e.g., each character, each symbol, etc.) of Font A (310).

Upon receiving ED A (300), the printer determines whether Font A (310) is supported. In other words, the printer determines whether the attributes of Font A (310) are stored on the printer. In this example, it is assumed that the attributes of Font A (310) are not yet stored on the printer. However, as Font A (310) is embedded, the printer extracts the font attributes (305) from ED A (300), stores the extracted font attributes (305) on the printer, and generates Hardcopy A (320). As shown in FIG. 3, Hardcopy A (320) includes Printed Value A (330) (i.e., the text “TPS Report”) in “cursive” (i.e., Font A (310)).

Still referring to FIG. 3, ED B (350) also exists and is also described in OOXML. As shown in FIG. 3, specifies, using OOXML tags, that the text “The Greatest Movie Script Ever” is to be printed in “cursive” (i.e., Font A (310)). However, unlike ED A (300), ED B (350) does not include the font attributes of Font A (310). In other words, the attributes of Font A (310) are not embedded in ED B (350) and Font A (310) is not an embedded font in ED B (350).

Assume the printer receives ED B (350) after receiving ED A (300). Upon receiving ED B (300), the printer determines whether Font A (310) is supported. In other words, the printer determines whether the attributes of Font A (310) are stored on the printer. In this example, the attributes (305) of Font A (310) were extracted from ED A (300) and stored in the printer. Accordingly, even though Font A (310) is not embedded in ED B (350), the printer retrieves the previously extracted font attributes (305) from storage and generates Hardcopy B (370). As shown in FIG. 3, Hardcopy B (370) includes Printed Value B (380) (i.e., the text “The Greatest Movie Script Ever”) in “cursive” (i.e., Font A (310)).

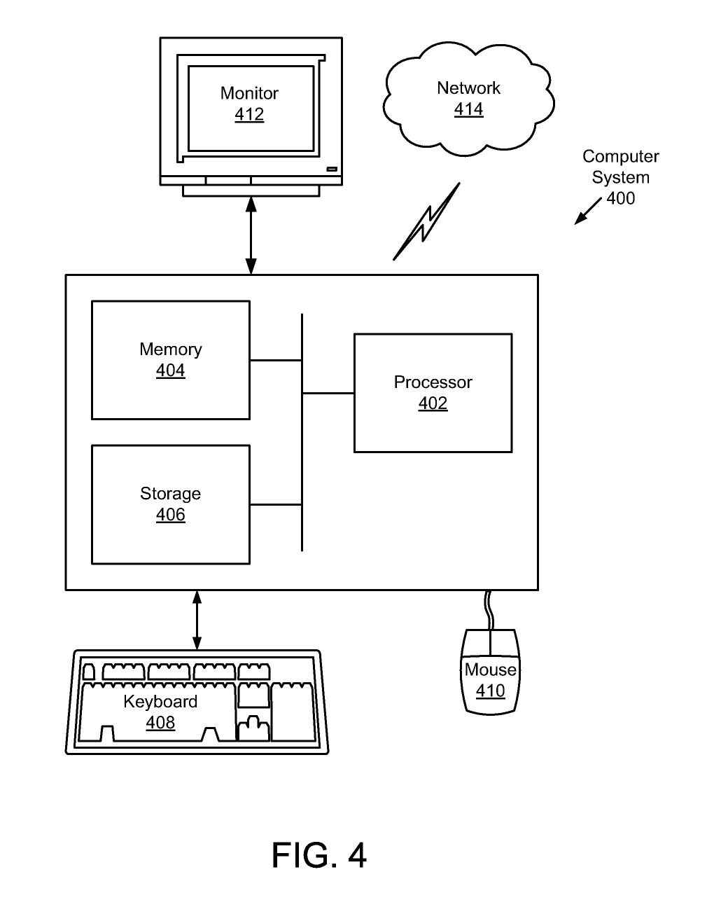

Embodiments of the invention may be implemented on virtually any type of computer regardless of the platform being used. For example, as shown in FIG. 4, a computer system (400) includes one or more processor(s) (402), an associated memory (404) (e.g. random access memory (RAM), cache memory, flash memory, etc.), a storage device (406) (e.g. a hard disk, an optical drive such as a compact disk drive or digital video disk (DVD) drive, a flash memory stick, etc.), and numerous other elements and functionalities typical of today's computers (not shown). In one or more embodiments of the invention, the processor (402) is hardware. For example, the processor may be an integrated circuit. The computer system (400) may also include input means, such as a keyboard (408), a mouse (410), or a microphone (not shown). Further, the computer system (400) may include output means, such as a monitor (412) (e.g. a liquid crystal display (LCD), a plasma display, or cathode ray tube (CRT) monitor). The computer system (400) may be connected to a network (414) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, the computer system (400) includes at least the minimal processing, input, and/or output means necessary to practice embodiments of the invention.

Further, in one or more embodiments of the invention, one or more elements of the aforementioned computer system (400) may be located at a remote location and connected to the other elements over a network. Further, embodiments of the invention may be implemented on a distributed system having a plurality of nodes, where each portion of the invention (e.g. the computing device, the multifunction printer) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing a font, comprising:
receiving, by a printer, a first electronic document (ED) identifying the font and embedding a plurality of attributes of the font;
determining, by the printer, that the plurality of attributes of the font is not stored on the printer;
storing, by the printer, the plurality of attributes of the font extracted from the first ED in a font storage unit; and
generating, by the printer and based on a layout of the first ED, a hardcopy of the first ED comprising a first printed value in the font.

2. The method of claim 1, further comprising:
receiving, by the printer, a second ED identifying the font, wherein the font is not embedded in the second ED;
determining, by the printer, that the plurality of attributes of the font is stored in the font storage unit;
retrieving, by the printer, the plurality of attributes of the font stored in the font storage unit; and
generating, based on a layout of the second ED and using the plurality of attributes retrieved from the font storage unit, a hardcopy of the second ED comprising a second printed value in the font.

3. The method of claim 1, wherein the first ED is described in OOXML.

4. The method of claim 1, wherein the printer is a Multi-Function Printer (MFP) comprising at least one selected from a group consisting of a fax module and a scanner.

5. The method of claim 1, wherein determining that the plurality of attributes is not stored on the printer comprises:
comparing the font with a plurality of printer supported fonts.

6. The method of claim 1, wherein the plurality of attributes comprises an alphabet of characters in the font.

7. The method of claim 1, wherein the ED is received from a mobile device.

8. A non-transitory computer-readable medium (CRM) storing a plurality of instructions for managing a font, the plurality of instructions comprising functionality to:
receive, using a printer, a first electronic document (ED) identifying the font and embedding a plurality of attributes of the font;
determine, using the printer, that the plurality of attributes of the font is not stored on the printer;
store the plurality of attributes of the font extracted from the first ED in a font storage unit on the printer; and
generate, using the printer and based on a layout of the first ED, a hardcopy of the first ED comprising a first printed value in the font.

9. The non-transitory CRM of claim 8, the plurality of instructions comprising further functionality to:
receive, using the printer, a second ED identifying the font, wherein the font is not embedded in the second ED;
determine, using the printer, that the plurality of attributes of the font is stored in the font storage unit on the printer;
retrieve the plurality of attributes of the font stored in the font storage unit on the printer; and
generate, based on a layout of the second ED and using the plurality of attributes retrieved from the font storage unit, a hardcopy of the second ED comprising a second printed value in the font.

10. The non-transitory CRM of claim 8, wherein the first ED is described in OOXML.

11. The non-transitory CRM of claim 8, wherein the printer is a Multi-Function Printer (MFP) comprising a processor and a memory.

12. The non-transitory CRM of claim 8, wherein the instructions further comprise functionality to:
compare the font with a plurality of printer supported fonts.

13. The non-transitory CRM of claim 8, wherein the plurality of attributes comprises an alphabet of characters in the font.

14. The non-transitory CRM of claim 8, wherein the ED is received from a mobile device.

15. A printer for managing a font, comprising:
a processor;
a font storage unit;
an input module executing on the processor and configured to:
receive a first electronic document (ED) identifying a font and embedding a plurality of attributes of the font; and
receive a second ED identifying the font but not embedding the plurality of attributes;
a parsing module operatively connected to the storage unit and configured to:
determine, during a parsing of the first ED, that the plurality of attributes is not stored in the font storage unit;
store the plurality of attributes in the font storage unit;
determine, during a parsing of the second ED, that the plurality of attributes is stored in the font storage unit; and
retrieve the plurality of attributes from the font storage unit; and
a layout engine executing on the processor and configured to:
generate a hardcopy of the first ED comprising a first printed value in the font; and
generate, after the plurality of attributes are retrieved from the font storage unit, a hardcopy of the second ED comprising a second printed value in the font.

16. The printer of claim 15, wherein the first ED is described in OOXML.

17. The printer of claim 15, further comprising:
a scanner; and
a fax module executing on the processor.

18. The printer of claim 15, wherein the parsing module is further configured to:
compare the font with a plurality of printer supported fonts.

19. The printer of claim 15, wherein the plurality of attributes comprises an alphabet of characters in the font.

20. The printer of claim 15, wherein the first ED is received from a mobile device.
